(19) United States
(12) Patent Application Publication
(10) Pub. No.: US 2013/0286227 A1
(43) Pub. Date: Oct. 31, 2013

(54) Data Transfer Reduction During Video Broadcasts

(71) Applicant: T-MOBILE USA, INC., Bellevue, WA (US)

(72) Inventors: Kevin Lau, Issaquah, WA (US); Jie Hui, Mercer Island, WA (US); Pablo Tapia, Snoqualmie, WA (US); Alexandru Catalin Ionescu, Bellevue, WA (US)

(73) Assignee: T-MOBILE USA, INC., Bellevue, WA (US)

(21) Appl. No.: 13/832,883

(22) Filed: Mar. 15, 2013

Related U.S. Application Data
(60) Provisional application No. 61/640,573, filed on Apr. 30, 2012.

(51) Int. Cl. G06F 3/00

(52) U.S. Cl. CPC G06F 3/005
USPC 348/207.1

(57) ABSTRACT

The techniques and systems described herein are directed, in part, to interactions between one or more mobile device applications, mobile device modems (or communication hardware), networks, and other devices. In some embodiments, a device may record a video using a camera. The device may then increase a block size of a first portion of a frame in the video to create a modified video where the first portion includes a larger block size than a second portion of the frame of the modified video. The increased block size may reduce an amount of data used to transmit the modified video to another device using the network communication.

### CROSS REFERENCE TO RELATED PATENT APPLICATION

This patent application claims the benefit and priority to Provisional U.S. Patent Application No. 61/640,573, titled, “Fast as Home”, filed on Apr. 30, 2012, the entire disclosure of which is incorporated by reference herein.

### BACKGROUND

Today's mobile devices are often equipped with processors that can perform many tasks, such as run various applications, record data, play media, and perform other tasks for a user. Mobile devices include telecommunication devices, Wi-Fi devices, and other devices having connectivity to a network. Although these devices have powerful processing capabilities, they often have to compete to access limited resources when transmitting data to other devices and receiving data from other devices. For example, when a mobile device captures a video, the mobile device's processors may be able to quickly store the video locally on the mobile device. However, when the mobile device uploads the video to another device, the mobile device may experience time and data constraints imposed by a network. For example, the network may have variable bandwidth or limited bandwidth, which may delay the upload of the video or other data.

Mobile devices often use processing power to encode/decode data. For example, a codec may be used to reduce a size of data using a codec algorithm. The reduced size of data is beneficial when transmitting data to other devices using the network because less bandwidth is needed to transmit the data. However, using the same encoding/decoding algorithm, even with rate control, may not adapt well to changing environments that the mobile device may experience during operation and during transmission of data.

### DESCRIPTION OF DRAWINGS

Non-limiting and non-exhaustive examples are described with reference to the following figures. In the figures, the left-most digit(s) of a reference number identifies the Fig. in which the reference number first appears. The use of the same reference numbers in different figures indicates similar or identical items or features.

FIG. 1 is schematic diagram of an illustrative environment that provides connectivity between a plurality of mobile devices.

FIG. 2 is a block diagram of selected components of an illustrative mobile device configured to encode/decode data exchanged with another device via a network.

FIG. 3 is a block diagram of selected components of an illustrative intermediary device that facilitates communications between the plurality of mobile devices.

FIG. 4 is a flow diagram of an illustrative process to facilitate communications between a modem of a mobile device and a communications application running on the mobile device.

FIG. 5 is a flow diagram of an illustrative process to adjust data transmission to a device based on a signal or received data from the device.

FIG. 6 is a flow diagram of an illustrative process to flush a modem buffer.

FIGS. 7-11 are pictorial flow diagrams of illustrative encoding techniques to reduce an amount of data of imagery transmitted during a real-time video broadcast.

FIG. 12 is a flow diagram of an illustrative process to begin a real-time video broadcast with a low quality encoding and then transition to an increased quality encoding.

FIG. 13 is schematic diagram of providing multiple streams of additive data to a mobile device.

FIG. 14 is a flow diagram of an illustrative process to implement greedy scheduling of data to be transmitted from a mobile device to another mobile device.

FIG. 15 is a flow diagram of an illustrative process to forecast network activity and then adjust encoding of data based in part on the forecasted network activity.

### DETAILED DESCRIPTION

### Overview

The techniques and systems described herein are directed, in part, to interactions between one or more mobile device applications, mobile device modems (or communication hardware), networks, and other devices. While the following discussion describes capture and transmission of a real-time video broadcast (e.g., a video chat, etc.), the techniques and systems may be implemented with other applications that perform other tasks and transmit data over various types of networks. Generally speaking, the techniques and systems discussed herein may enable improved transmission of imagery and rendering of imagery by mobile devices while performing some tasks, such as broadcasting real-time videos.

In some embodiments, a mobile device may be configured to allow an application to monitor and communicate with the mobile device's modem. This communication may provide visibility by the application to scheduling performed by the modem, buffer levels of the modem, and/or other relevant data. In some instances, the mobile device may communicate with another device to determine scheduling throughput of the other device. For example, the other device may have a slow downlink data connection. When the mobile device and the other device exchange data, the mobile device may be made aware of the slow downlink data connection of the other device and then take appropriate action to reduce or minimize the amount of data that is transmitted to the other device.

In accordance with some embodiments, the mobile device may adjust encoding, resolution, and/or frame rate of imagery captured by the mobile device. For example, the encoder may reduce the resolution of non-essential pixels in an image. In another example, the encoder may reduce the frame rate of imagery received from a camera. The encoder may also use multiple streams of data to transmit information to another mobile device. The multiple streams of data may be additive, thereby providing additional data in each additional stream that can be used to improve imagery received by the other device.

In various environments, intermediary devices that facilitate communications between of the mobile device and the other device, and may intervene or provide other data to increase throughput of data between the two devices. For example the intermediary device they implement unfair scheduling. The intermediary device may also perform network bandwidth forecasting to enable the mobile device to proactively select an appropriate encoding for data that is to be transmitted to the other device.

### Illustrative Environment

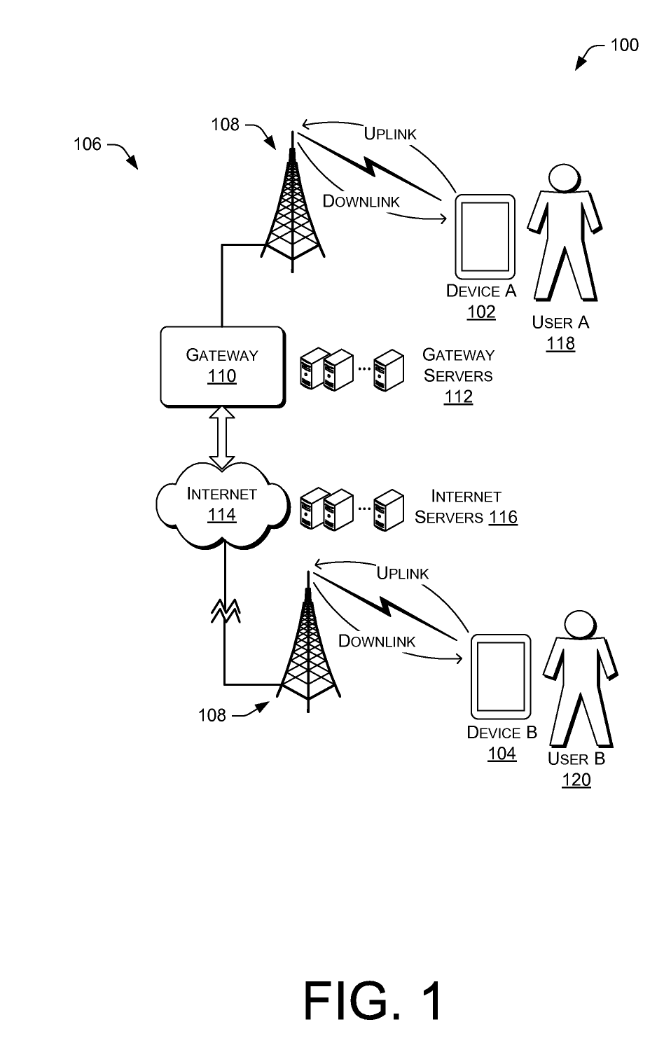

FIG. 1 is schematic diagram of an illustrative environment 100 that provides connectivity between a plurality of mobile devices. The environment 100 includes a mobile device 102, which is also referred to herein as device A. The mobile device 102 may be in communication with another mobile device 104, which is also referred to herein as device B. The mobile devices 102 and 104 may be telecommunications devices and may include mobile telephones (including smartphones), netbooks, tablet computers, personal computers, data sticks, network adapters, and other electronic devices that can exchange signals, such as radio signals.

The mobile devices 102 and 104 may exchange data through a network 106. The network 106 may include a plurality of hardware, software, and other infrastructure. The environment 100 shows an illustrative arrangement of the network 106; however, other arrangements may be used to facilitate transmission of data between the mobile devices 102 and 104.

In a telecommunications environment, the network 106 may include various configurations of telecommunications networks that include radio access networks (RANs) 108 used for mobile communications. The telecommunications networks may include a gateway 110 and may include a number of different types of components, which may be provided by various companies. In some instances, the telecommunications networks may conform to Universal Mobile Telecommunications System (UMTS) technologies that employ UMTS Terrestrial Radio Access Network (UTRAN). In some instances, the UTRAN may share a several components like a Circuit Switch (CS) and a Packet Switch (PS) core network with a GSM EDGE Radio Access Network (GERAN) (Global System for Mobile Communications (GSM), Enhanced Data rates for GSM Evolution (EDGE)). In various instances, long term evolution (LTE) networks may be employed to transmit data for the telecommunications networks besides UMTS. Thus, UTRAN and GERAN networks (and other possible RANs) may coexist to process telecommunications traffic. In some instances, communications may be handed off between UTRAN and GERAN networks (or other networks) and still maintain a communication with a common core network, such as when a mobile device leaves a range of access (zone) of a UTRAN and enters a range of access of a GERAN. Handoffs may also occur between different types of hardware (e.g. different manufacturers, versions, etc.) for a same network type (e.g., UTRAN, GERAN, etc.). In addition, other types of networks, RANs, and/or components (hardware and/or software) may be employed which enable mobile devices to communicate with the core network to facilitate activities such as voice calling, messaging, emailing, accessing the Internet, or other types of data communications. For example, the network 106 may be, at least in part, a Wi-Fi based network, a Bluetooth network, or other type of wireless network. The gateway 110 may include gateway servers 112 that perform some or all of the functions of the gateway 110.

In accordance with various embodiments, the gateway 110 may be in communication with the Internet 114. The Internet 114 may include Internet servers 116. The gateway 110 and the Internet 114 may be in communication with the RAN's 108. The mobile devices 102 and 104 may upload data to the RAN via an uplink communication and may download data from the RAN 108 via a downlink communication. The mobile device 102 may be associated with a user 118 while the mobile device 104 may be associated with a user 120. During an interaction the users 118 and 120 may conduct a real time video broadcast such as a video chat using the mobile devices 102 and 104. In some embodiments, the mobile device 104 may be in communication with the internet 114 via a wired connection.

### Illustrative Devices

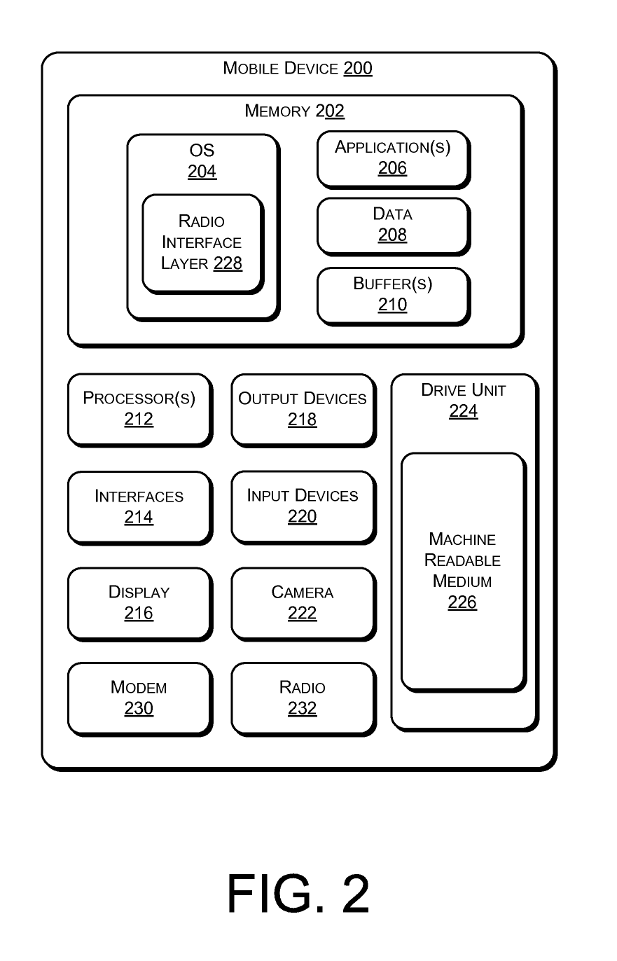

FIG. 2 is a block diagram of selected components of an illustrative mobile device 200 configured to encode/decode data exchanged with another device via a network. As shown, the mobile device 200 (such as the mobile device 102 and/or 104) may include a memory 202, the memory storing an operating system (OS) 204, application(s) 206, data 208, and/or buffer(s) 210. The mobile device 200 further includes processor(s) 212, interfaces 214, a display 216, output devices 218, input devices 220, a camera 222, and drive unit 224 including a machine readable medium 226. The mobile device 200 may also include a radio interface layer (RIL) 228, a modem 230, and a radio 232. In some embodiments, the processor(s) 206 is a central processing unit (CPU), a graphics processing unit (GPU), or both CPU and GPU, or other processing unit or component known in the art.

In various embodiments, memory 202 generally includes both volatile memory and non-volatile memory (e.g., RAM, ROM, EEPROM, Flash Memory, miniature hard drive, memory card, CD-ROM, digital versatile disks (DVD) or other optical storage, magnetic cassettes, magnetic tape, magnetic disk storage or other magnetic storage devices, or any other medium). Additionally, in some embodiments, memory 202 includes a SIM (subscriber identity module) card, which is a removable memory card used to identify a user of the mobile device 200 to a service provider network. Memory 202 can also be described as computer storage media and may include volatile and nonvolatile, removable and non-removable media implemented in any method or technology for storage of information, such as computer readable instructions, data structures, program modules, or other data.

In various embodiments, the interfaces 214 are any sort of interfaces known in the art. Interfaces 214 include any one or more of an Ethernet interface, wireless local area network (LAN) interface, a near field interface, a DECT chipset, or an interface for an RJ-11 or RJ-42 port. The a wireless LAN interface can include a Wi-Fi interface or a Wi-Max interface, or a Bluetooth interface that performs the function of transmitting and receiving wireless communications using, for example, the IEEE 802.11, 802.16 and/or 802.20 standards. For instance, the mobile device 200 can use a Wi-Fi interface to communicate directly with a nearby device. The near field interface can include a Bluetooth® interface or radio frequency identifier (RFID) for transmitting and receiving near field radio communications via a near field antenna. For example, the near field interface may be used for functions, as is known in the art, such as communicating directly with nearby devices that are also, for instance, Bluetooth® or RFID enabled. A reader/interrogator may be incorporated into mobile device 200.

In various embodiments, the display 216 is a liquid crystal display or any other type of display commonly used in telecommunication devices. For example, display 216 may be a touch-sensitive display screen, and can then also act as an input device or keypad, such as for providing a soft-key keyboard, navigation buttons, or the like.

In some embodiments, the output devices 218 include any sort of output devices known in the art, such as a display (already described as display 216), speakers, a vibrating mechanism, or a tactile feedback mechanism. The output devices 218 also include ports for one or more peripheral devices, such as headphones, peripheral speakers, or a peripheral display.

In various embodiments, the input devices 220 include any sort of input devices known in the art. For example, the input devices 220 may include a microphone, a keyboard/keypad, or a touch-sensitive display (such as the touch-sensitive display screen described above). A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

The machine readable medium 226 stores one or more sets of instructions (e.g., software) embodying any one or more of the methodologies or functions described herein. The instructions may also reside, completely or at least partially, within the memory 202 and within the processor 212 during execution thereof by the mobile device 200. The memory 202 and the processor 212 also may constitute machine readable media 226.

The RIL 228 may reside in the OS 204 and be a layer that provides an interface to the radio 232 and the modem 230 on the mobile device 200. The modem 230 may receive data from the application(s) 206, such as through one of the buffer(s) 210 associated with an application, and produce a signal or signals that can be transmitted by the radio 232 over the network 106. The modem 230 may be aware of an uplink scheduling ability and other network metrics. The modem 230 may have a buffer, which may be included in the buffer(s) 210, by which the modem 230 may store data prior to the data being transmitted through the network via the radio 232.

The radio 232 may be a transceiver. The radio 232 may include a radio transceiver and interface that performs the function of transmitting and receiving radio frequency communications via an antenna. The radio interface facilitates wireless connectivity between the mobile device 200 and various cell towers, base stations and/or access points.

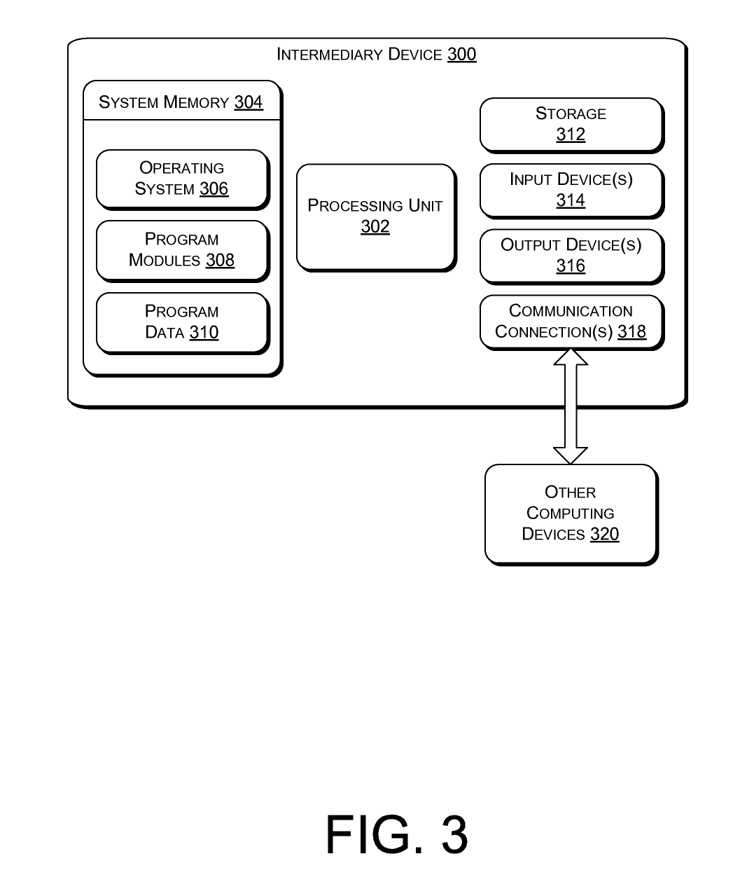

FIG. 3 is a block diagram of selected components of an illustrative intermediary device 300 that facilitates communications between the plurality of mobile devices, such as the mobile devices 102 and 104. The intermediary device may be representative of the gateway 110 or other computing devices shown in the environment 100 shown in FIG. 1. In various embodiments, computing device 300 may include at least one processing unit 302 and system memory 304. Depending on the exact configuration and type of computing device, system memory 304 may be volatile (such as RAM), non-volatile (such as ROM, flash memory, etc.) or some combination of the two. The system memory 304 may include an operating system 306, one or more program modules 308, and may include program data 310.

Computing device 300 may also include additional data storage devices (removable and/or non-removable) such as, for example, magnetic disks, optical disks, or tape. Such additional storage is illustrated in FIG. 3 by storage 312. Computer storage media may include volatile and nonvolatile, removable and non-removable media implemented in any method or technology for storage of information, such as computer readable instructions, data structures, program modules, or other data. The system memory 304 and storage 312 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 300. Any such computer-readable storage media may be part of the computing device 300.

In various embodiment, any or all of the system memory 304 and the storage 312 may store programming instructions which, when executed, implement some or all of the above-described operations of the gateway 110 or other components described in the environment 100 shown in FIG. 1.

Computing device 300 may also have input device(s) 314 such as a keyboard, a mouse, a touch-sensitive display, voice input device, etc. Output device(s) 316 such as a display, speakers, a printer, etc. may also be included. These devices are well known in the art and need not be discussed at length here. Computing device 300 may also contain communication connections 318 that allow the device to communicate with other computing devices 320.

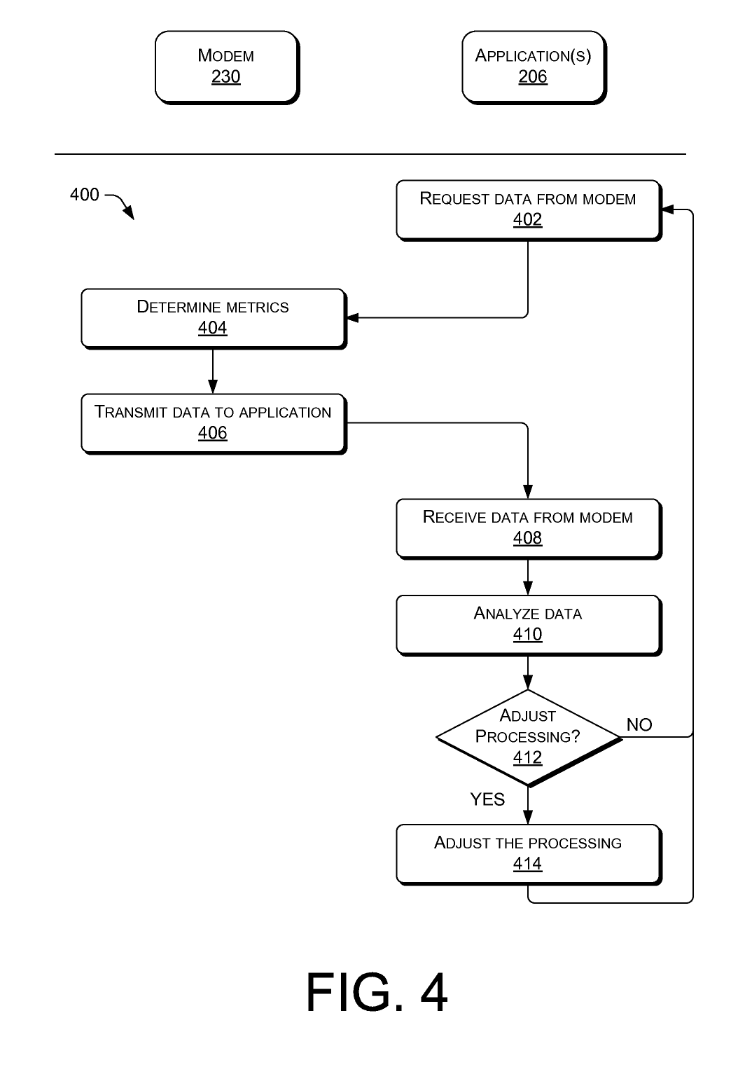

In various embodiments, the intermediary device 300 may be configured to communicate and exchange data with the RANs 108 and/or the Internet 114 as part of the network 106. The intermediary device 300 may manage bandwidth allocations, perform bandwidth and scheduling analyses, and/or provide data to the mobile devices 102 and 104, including and in addition to the data exchanged between the mobile devices. The intermediary device 300, as well as the mobile device 200, may be used to perform some or all o the functions described below with reference to FIGS. 4-15.

### Illustrative Encoder Signaling and Buffer Management

FIGS. 4-6 show illustrative processes of providing encoder signaling and buffer management. The processes are illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 4 is a flow diagram of an illustrative process 400 to facilitate communications between a modem of a mobile device and a communications application running on the mobile device. The operations shown in FIG. 4 are organized under components that may perform their respective operations, such as the application 206 and/or the modem 230. However in some embodiments, other components may perform the operations. The process 400 may enable a cross-layer data sharing between an application and the modem 230. The application may then be able to make adjustments to encoding or other adjustments using the data (e.g., status) received from the modem 230, such as a status of the uplink scheduling performed by the modem 230.

At 402, the application 206 may request data from the modem 230. For example, the application 206 may request a fill level of the modem's buffer, a current scheduling status, or at other data associated with the modem. The modem's fill level may indicate a quality of a network communication used by the modem.

At 404, the modem 230 may determine metrics associated with the modem. For example, the modem may generate a report or otherwise compile data related to various metrics.

At 406, the modem 230 may transmit data to the application 206. The data may provide a status related to activities performed by the modem 230. In some instances, the modem 206 may transmit the data determined from the metrics at the operation 404.

At 408, the application 206 may receive the data from the modem 230. For example, the application 230 may receive the data from the modem 230 via the RIL 228.

At 410, the application 206 may analyze the data received from the operation 408. The analysis may include a comparison of a value against the threshold value, use of a look up table, or other analysis to determine a state of the modem or tasks associated with the modem.

At 412, the application 206 may determine whether to adjust processing by the application based at least in part on the analysis performed at the operation 410. When the application determines to adjust the processing (following the “yes” route), then processing may continue at an operation 416. However, when the application determines not to adjust the processing (following the “no” route), then processing may continue at the operation 402.

At 414, the application 206 may adjust the processing based at least in part on the data from the modem 230 in the analysis performed at the operation 410.

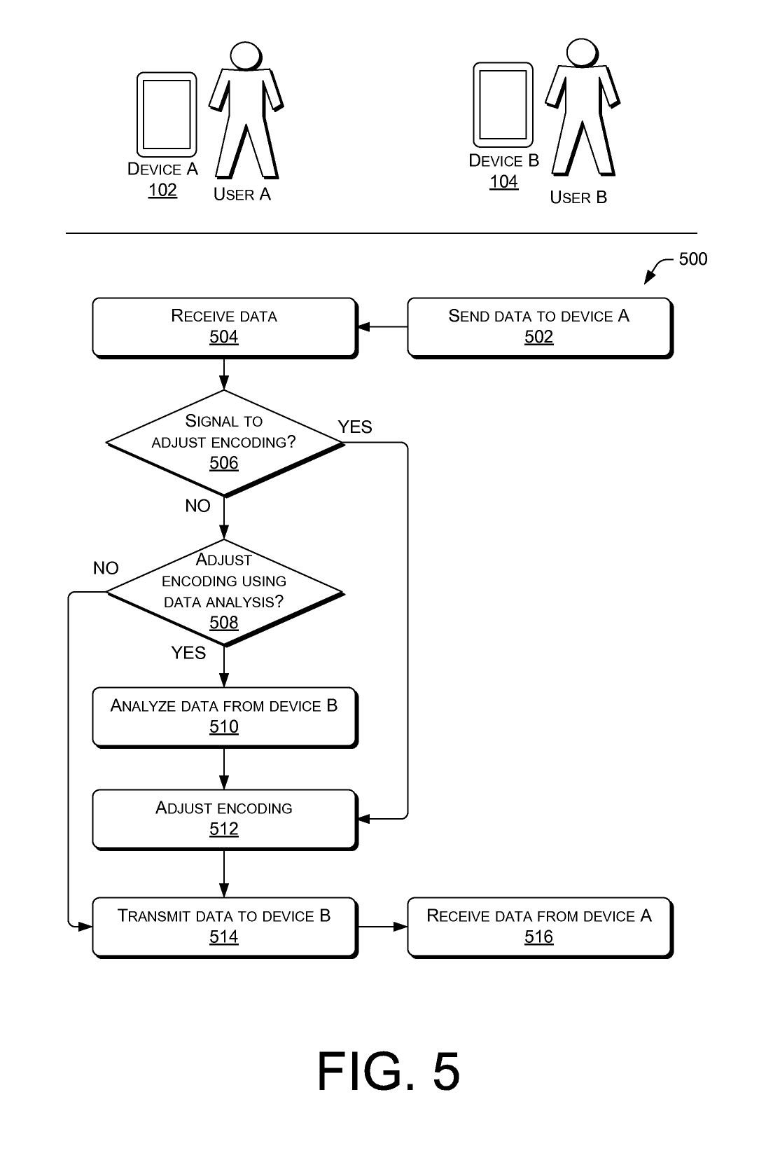

FIG. 5 is a flow diagram of an illustrative process 500 to adjust data transmission to a device based on a signal or received data from the device. The operations shown in FIG. 5 are organized under components that may perform their respective operations, such as the mobile devices 102 and 104. However in some embodiments, other components may perform the operations.

At 502, the mobile device 104 may send data to the mobile device 102. The data may be application data such as media content or the data may be a signal. For example, the signal may be transmitted to the mobile device 102 using a header field or metadata. At 504, the mobile device 102 may receive the data.

At 506, the mobile device 102 may determine whether the data is a signal to adjust encoding. When the data is not a signal to adjust encoding (following the “no” route), then the process may advance to a decision operation 508.

At 508, the mobile device 102 may adjust encoding using data analysis of the data received the operation 504. When the mobile device 102 determines to adjust the encoding using data analysis (following the “yes” route), then the processing may continue at an operation 510.

At 510, the mobile device 102 may analyze data received from the mobile device 104. For example, the mobile device 102 may determine a resolution of the data transmitted from the mobile device 104. In some embodiments, the determination may be performed using heuristics. When the quality (e.g., resolution, frame rate, image size, etc.) is lower than the quality previously received from the mobile device 104, then the mobile device 102 may infer that the mobile device 104 suffers from a lack of bandwidth or other transmission difficulties.

Following the operation 510, or the “no” route from the decision operation 506 after receipt of the signal, the mobile device 102 may adjust the encoding performed by the application at 512. For example, the application 206 may decide to encode data for the mobile device 104 using a different compression, a different resolution, and/or a different frame rate than currently used by the application. And by adjusting the encoding, the mobile device 102 may provide data to the mobile device 104 that is more readily processed through the network 106 in accordance with current quality of the network or other factors that may influence the data exchange rate between the mobile devices. The signal may be generated by the mobile device 104, the intermediary device 300, the RAN 108, or another device. The quality of the network may include delay, throughput, signal strength, packet loss, capacity, interference, and/or other factors commonly used to measure quality of a network communication.

Following the operation 512, or the “no” route from the decision operation 508, the mobile device 102 may transmit the data to the mobile device 104 at 514. At 516, the mobile device 104 may receive the data.

In some embodiments, when the mobile devices employ the decision operation 508, one of the mobile devices may be designated as a master to employ the adjustment while the other mobile devices do not perform the adjustment while they are not designated as the master. The role master may rotate amongst the mobile devices. By using this master relationship, the mobile devices may avoid continually lowering the quality of the data transmitted to other devices over time in a cyclical nature.

In various embodiments, the intermediary device 300 may perform the operations in lieu of the mobile device 102, and thus downsize the data transmitted from the mobile device 102 to the mobile device 104.

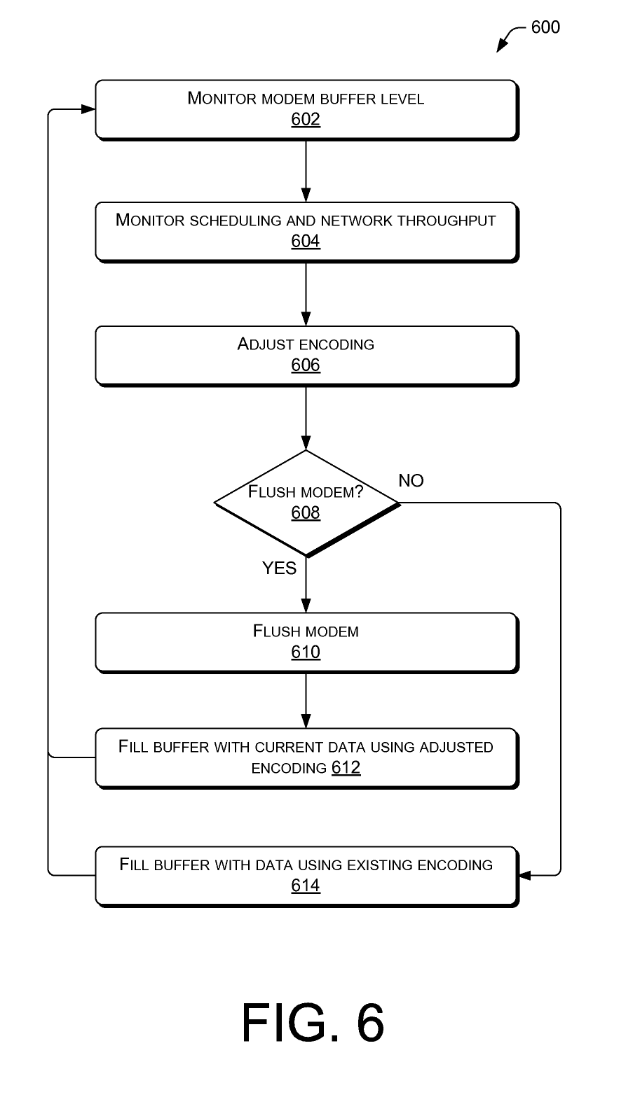

FIG. 6 is a flow diagram of an illustrative process 600 to flush a modem buffer. The process 600 may be performed by the application 206 and/or the modem 230. However, other components may be used to perform the operations in the process 600.

At 602, the application 206 may monitor the buffer level of the modem 230. For example the application 206 may receive a status of the buffer level from the modem 230 via a communication from the modem to the application (e.g., via the process 400).

At 604, the application 206 may monitor scheduling and network quality. For example the application 206 may receive data from the modem 230 that indicates current scheduling or other attributes of the network quality.

At 606 the application may adjust a rate of encoding. For example when the modem 230 indicates a relatively high buffer level at the operation 602 or limited network throughput at the operation 604, then the encoding may be adjusted to reduce the amount of data transmitted by the modem to another device. Conversely, when the modem 230 indicates a relatively low buffer level of the operation 206 or unused network throughput at the operation 604, then the encoding may be adjusted to increase the amount of data transmitted by the modem 230 to another mobile device. The increase may be in response to an improved quality of data created by the application for the other mobile device.

At 608, the application 206 may determine whether to flush the modem's buffer. The modem buffer may be flushed, or otherwise emptied, when the application 206 adjusts the encoding at the operation 606. When the application 206 determines to flush of the modem buffer at the decision operation 608 (following the “yes” route), than the process may advance to the operation 610. At 610, the modem buffer may be flushed to remove data within the buffer. In some instances, only a particular type of data may be flushed from the modem buffer, such as video data, while maintaining other types of data, such as audio data.

At 612, the application 206 may fill the buffer with current data using the adjusted encoding from the operation 606. Following the operation 612, the process 600 may return to the operation 602.

When the application 206 determines not to flush of the modem buffer at the decision operation 608 (following the “no” route), then the process 600 may continue at an operation at 614.

At 614, the application 206 may fill the buffer with data using existing encoding.

### Illustrative Encoding, Block Size, and Frame Rate Techniques

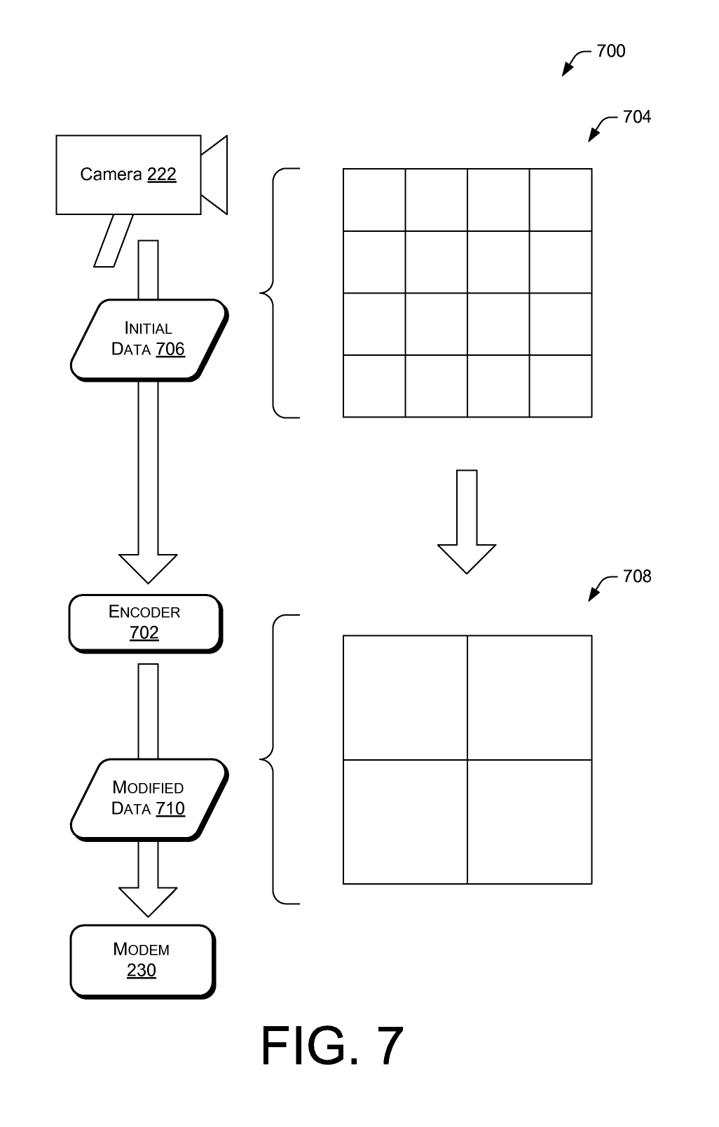

FIGS. 7-10 are pictorial flow diagrams of illustrative encoding techniques to reduce an amount of data used to reproduce imagery. The reduced amount of data may then be more readily transmitted across the network 106 during a real-time video broadcast even when the network is experiencing congestion. The FIGS. 7-10 show initial data captured by a camera 222. The initial data may also include audio, metadata, and/or other types of information. In accordance with one or more embodiments, the initial data may then be encoded by an encoder 702 to create modified data. The encoder 702 may be a component of one of the applications 206, a stand-alone application, a plug-in, a module, or other software that can convert the initial data to the modified data.

In accordance with various embodiments, the techniques described below may be implemented using a camera autofocus mechanism to inform a video encoder of specific spatial regions to use smaller block sizing for better effective picture quality. In a case where a camera supports motile focus points, these techniques may be applied to multiple of the spatial regions. Use of adjacent raw picture frames (i.e. frame 1 to frame 2) may be used to determine areas in which there are high motion vectors. An inference may be that the high motion vector areas are “important” and therefore should receive smaller block sizing in these areas. This could improvement visual quality as the user may be more focused on the moving object rather than the stationary objects in a video.

The FIGS. 7-12 show illustrative processes that are illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 7 shows an illustrative environment 700 including a block of pixels 704 that represents initial data 706 captured by the camera 222. The initial data 706 may be images recorded by the camera as part of a real time video broadcast (e.g., video chat, etc.). The initial data 706 may be processed by the encoder 702 to create another block of pixels 708 that represents modified data 710 created by the encoder. The modified data 710 may require less storage space and therefore be more readily transmitted across the network 106 by the modem 230. The modified data 710 may be imagery having a larger block size than the initial data 706. For example, the block of pixels 704 may be a 4×4 block of pixels while the other block of pixels 708 (corresponding to the modified data 710) may be a 2×2 block of pixels. Thus, the encoder may increase the block size by a factor, such as a factor of four in this example (however, other factors or compression rates may be used). In some embodiments, the reduction of the pixels may combine two pixels to a single pixel. Thus, not all block size changes performed by the encoder may be a multiple of two (base-two). The amount of the increase in the block size may be determined dynamically based on information from the modem (e.g., via the process 400), and/or by other information available to the application 206 or the mobile device 102. For example, when bandwidth is particularly scarce, the block size may increase from 4×4 to 1×1 (e.g., one large block instead of sixteen small blocks) instead of from 4×4 to 2×2 (as provided in the example above). Ultimately, the modem 230 may receive the modified data for transmission to another device via the network 106.

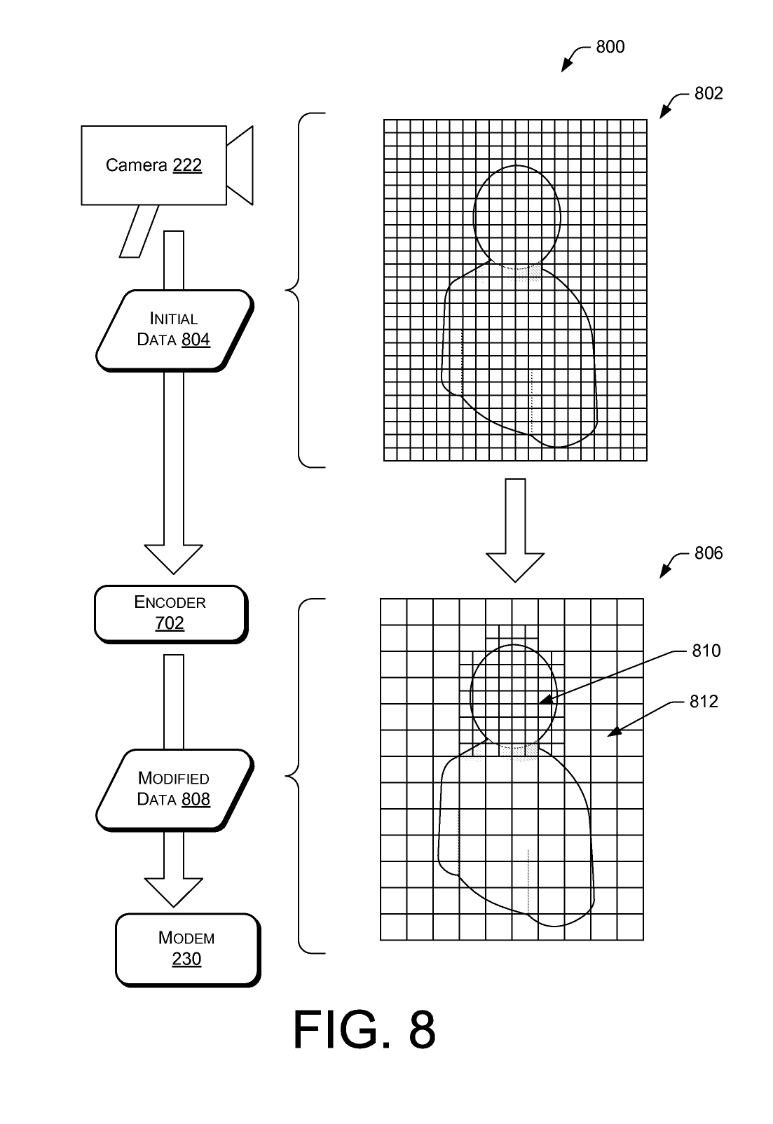

FIG. 8 shows an illustrative environment 800 including a block of pixels 802 that represents initial data 804 captured by the camera 222. The initial data 804 may be images recorded by the camera as part of a real time video broadcast (e.g., video chat, etc.). The initial data 804 may be processed by the encoder 702 to create another block of pixels 806 that represents modified data 808 created by the encoder. The modified data 808 may require less storage space and therefore be more readily transmitted across the network 106 by the modem 230. The modified data 808 may be imagery having a portion that includes a larger block size (e.g., lower local resolution) than the initial data 804. For example, the block of pixels 802 may have a first block size of x while the other block of pixels 806 (corresponding to the modified data 808) may include one or more portions 810 having the block size of x and one or more portions 812 having a block size of y, where y is greater than x. In some embodiments, the one or more portions 810 may be selected by the encoder 702 using face recognition to preserve a block size of the face while increasing the block size of other body parts. In various embodiments, the one or more portions 810 may be selected based on other criteria, such as a position within the frame (area of view of the camera 222), areas with text, or other areas. Thus, the encoder 230 may reduce the amount of data consumed by the image by increasing the block size of the one or more portions 812, thereby enabling the modem 230 to transmit or receive the modified data 808 more readily via the network 106 during a real-time video broadcast even when the network is experiencing congestion.

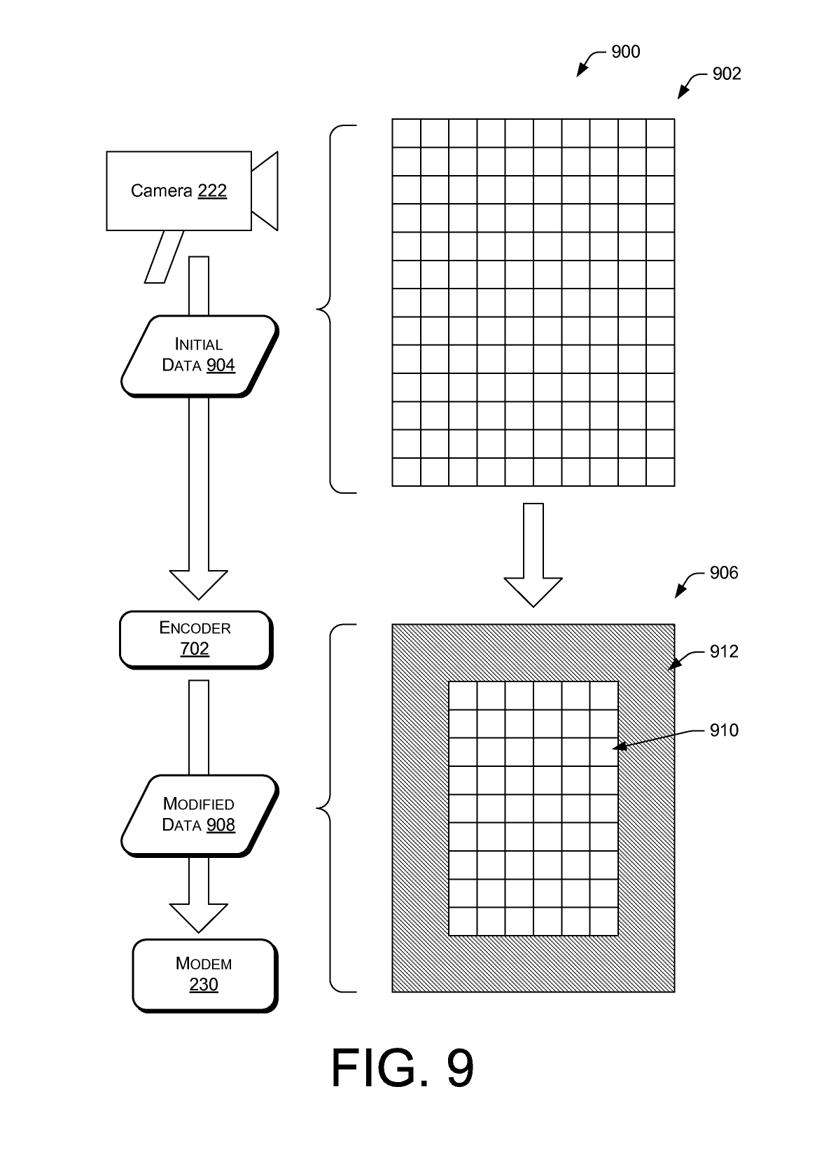

FIG. 9 shows an illustrative environment 900 including a block of pixels 902 that represents initial data 904 captured by the camera 222. The initial data 904 may be images recorded by the camera as part of a real time video broadcast (e.g., video chat, etc.). The initial data 904 may be processed by the encoder 702 to create another block of pixels 906 that represents modified data 908 created by the encoder. The modified data 908 may require less storage space and therefore be more readily transmitted across the network 106 by the modem 230. The modified data 908 may be imagery having a portion removed (e.g., blacked out, etc.) from the initial data 904. For example, the other block of pixels 906 (corresponding to the modified data 908) may include a portion 910 that is maintained from the initial data, while some of the data in the initial data 904 is removed (i.e., deleted, etc.) in a second portion 912, which may be a border of the first portion 910. The second portion 912 may be blacked out or otherwise stylized by a recipient device to fill in a void of the missing/deleted pixels of the second portion 912. The first portion 910 and second portion 912 may be selected by the encoder 702, such as by using a fixed or variable ratio, a fixed or variable size, and/or other threshold values or step-wise functions. In some embodiments, the encoder 230 may select the first portion 910 and the second portion 912 using face recognition to preserve a block size of the face while removing the pixels used to display other parts of a person. Thus, the encoder 230 may reduce the amount of data consumed by the image, thereby enabling the modem 230 to transmit or receive the modified data 908 more readily via the network 106 during a real-time video broadcast even when the network is experiencing congestion.

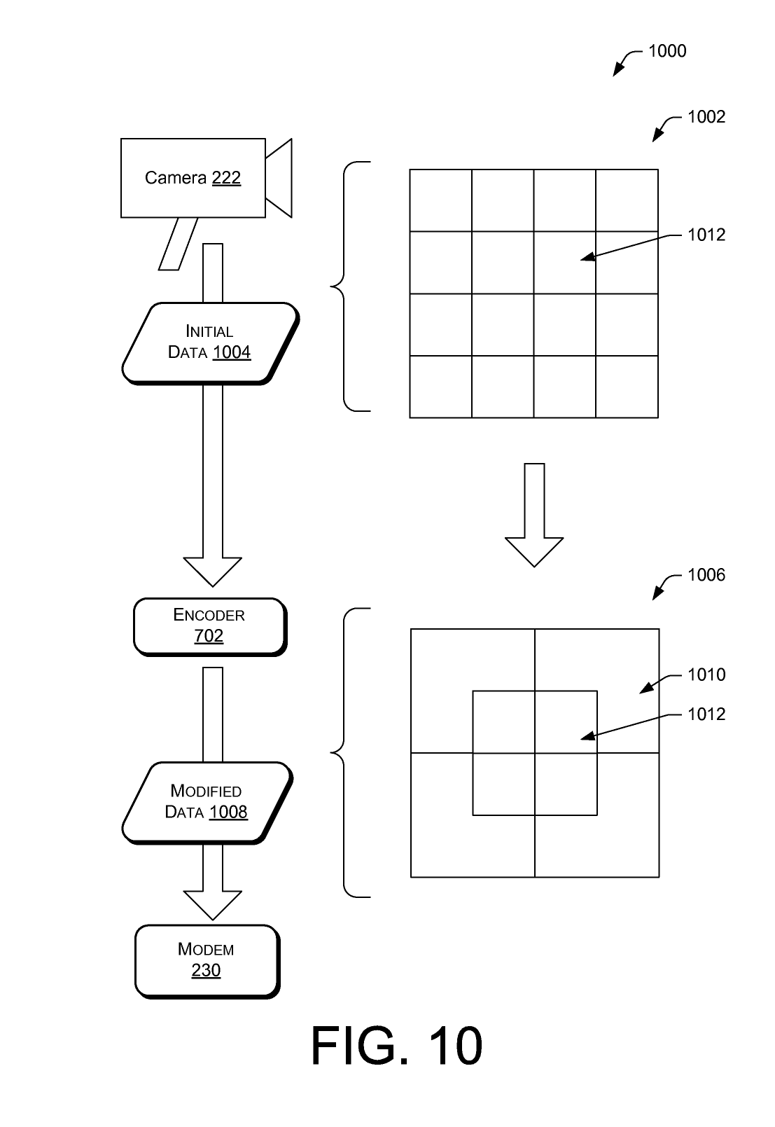

FIG. 10 shows an illustrative environment 1000 including a block of pixels 1002 that represents initial data 1004 captured by the camera 222. The initial data 1004 may be images recorded by the camera 222 as part of a real time video broadcast (e.g., video chat, etc.). The initial data 1004 may be processed by the encoder 702 to create another block of pixels 1006 that represents modified data 1008 created by the encoder. The modified data 1008 may require less storage space and therefore be more readily transmitted across the network 106 by the modem 230. The modified data 1008 may be similar to the modified data 710 show and discussed with reference to FIG. 7, but may include some additional detail for some pixels or locations. For example, a group of pixels 1010 may be representative of a larger number of pixels, similar to the increase in block size used to create the other block of pixels 708 in FIG. 7. However, the encoder 702 may overlay (or otherwise preserve some pixels 1012 with the group of pixels 1010). Thus, the encoder 230 may reduce the amount of data consumed by the image, thereby enabling the modem 230 to transmit or receive the modified data 1008 more readily via the network 106 during a real-time video broadcast even when the network is experiencing congestion.

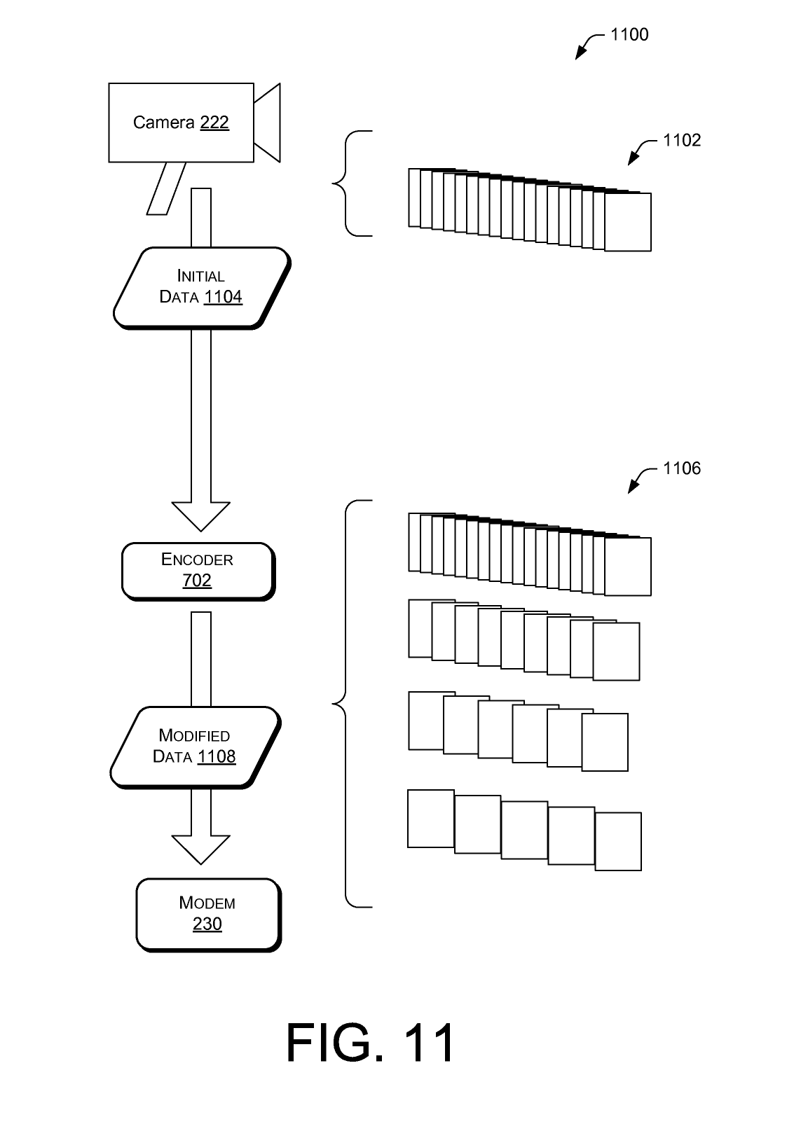

FIG. 11 shows an illustrative environment 1100 including a first series of frames 1102 that represents initial data 1104 captured by the camera 222. The initial data 1104 may be frames of images recorded by the camera as part of a real time video broadcast (e.g., video chat, etc.). The initial data 1004 may be processed by the encoder 702 to create a second series of frames 1106 that represents modified data 1008 created by the encoder. The modified data 1008 may require less storage space and therefore be more readily transmitted across the network 106 by the modem 230. In various embodiments, the encoder may reduce the frame rate of the series of images from a first frame rate captured by the camera 222 to second frame rate that is less than the first frame rate. By performing the processing by the encoder 702, the camera 222 may record images at a continuous frame rate regardless of a state of the modem 230, the buffers 210, and/or network availability. Instead, the encoder 230 may reduce the frames. Thus, the encoder 230 may reduce the amount of data consumed by the series of images, thereby enabling the modem 230 to transmit or receive the modified data 808 more readily via the network 106 during a real-time video broadcast even when the network is experiencing congestion.

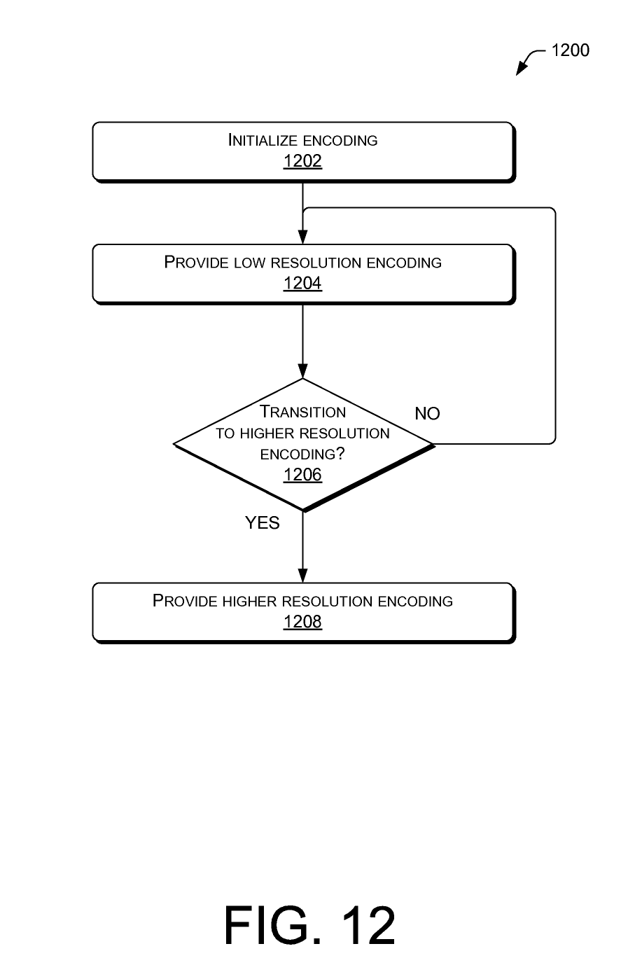

FIG. 12 is a flow diagram of an illustrative process 1200 to begin a real-time video broadcast with a low resolution (or high block size) encoding and then transition to an increased resolution (or low block size). The process 1200 may be performed by the mobile device 200, such as by an encoder (e.g., the encoder 702) of the application 206.

At 1202, the mobile device 200 may initialize encoding such as during the start of a real-time video broadcast. For example, the initialization may begin when the application 206 is opened or starts execution via the processors 212.

At 1204, the encoder may provide low resolution (or larger block size) encoding of imagery captured by the camera 200. For example, the encoder may provide imagery using a resolution (or block size) similar to that shown in the block of pixels 708 of FIG. 7.

At 1206, the mobile device 200 may determine whether to transition to a higher resolution (or smaller block size) encoding. When the mobile device 200 determines to transition to a higher resolution (or smaller block size) encoding (following the “yes” route), then the process may advance to an operation 1208. For example, the transition may be determined based on a predetermined amount of time, an achieved or realized network capacity, or based on other factors. When the mobile device 200 determines not to transition to a higher resolution (or lower block size) encoding (following the “no” route), then the process may advance to the operation 1204 and continue processing.

At 1208, the encoder may provide a higher resolution (or lower block size) encoding than the encoding provided at the operation 1204. For example, the encoder may provide imagery using a resolution (or block size) similar to that shown in the block of pixels 704 of FIG. 7. Therefore, the mobile device 200 may create data of a larger size (and higher quality) for imagery at the operation 1208 than at the operation 1204. The process 1200 may be advantageous to enable providing imagery to another device quickly while little data is available in a buffer and/or a network status is unknown.

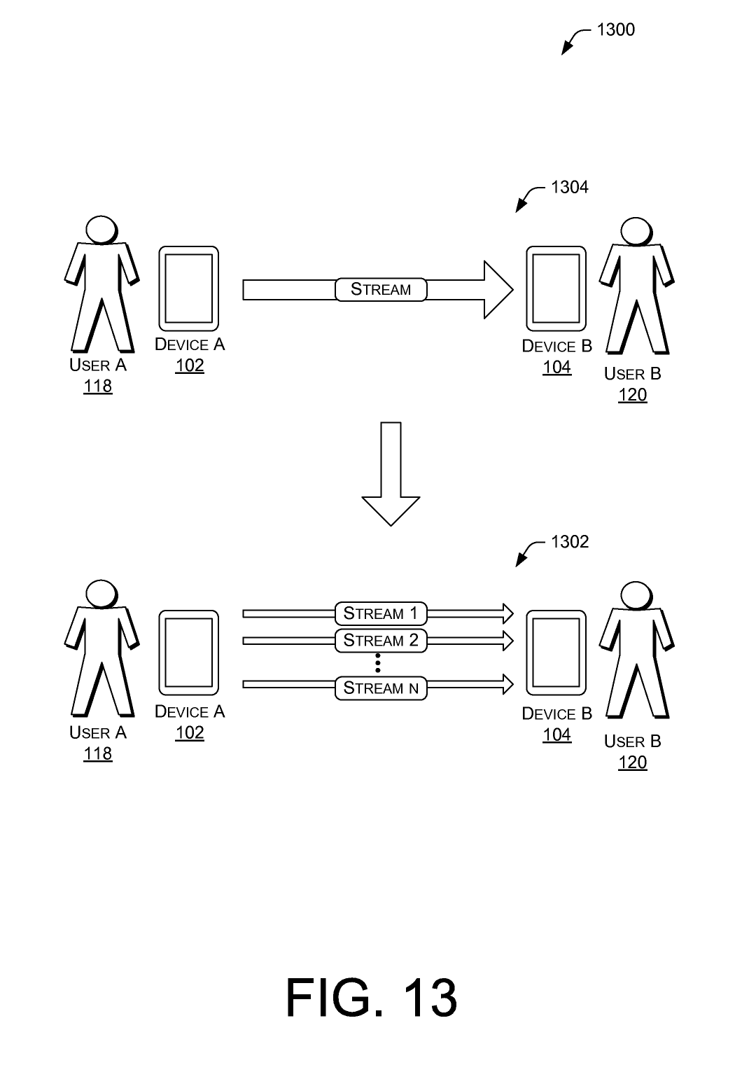

FIG. 13 is schematic diagram of an illustrative environment 1300 showing illustrative additive data streams 1302 that may be provided by the mobile device 200 via the network 106. In a typical transmission of data, the mobile device 102 may transmit data to the mobile device 104 via a single stream of data. The single stream of data 1304 may be transmitted by the modem and include the data necessary to recreate the imagery on the second device. The data may be transmitted in packets in the stream, where each packet includes data representative of a period of time. In accordance with one or more embodiments, the mobile device 102 may be configured to transmit data to the mobile device 104 using multiple streams of data that are additive, meaning the data in each stream may contain information that builds upon data in another stream.

The mobile device 102 may transmit the additive data streams 1302 in series (one after another) for each period of time, such that the mobile device 104 receives the streams one at a time. When the network capacity is low, the mobile device 102 may be unable to transmit all the streams of data. For example the mobile device 102 may only be able to transmit the first and second stream of data. A third stream may not be transmitted based on information provided by the modem 230 (via the process 400) or for other reasons. The mobile device 104 that receives the streams may then combine the data included in the first and second stream of data to render the imagery (in any other data included therein). In some instances, the mobile device 102 may transmit all of the streams of data while the mobile device may only render a portion of the streams received (e.g., may not be able to use all the streams of data). The mobile device 104 may only render a portion of the streams due to a slowdown link or other factors that prevent the mobile device 104 from receiving or processing all of the transmitted streams in a timely manner.

Each of the streams in the additive data streams 1302 may have an associated data size. For example, the first stream may have a data size of x kilobytes per second (kbps) while the second stream may have a data size of y kbps in a third stream may have a data size of z kbps. The values for x, y, z may or may not be the same. When the mobile device 104 is able to use streams one and two for rendering the imagery, the combined size of the additive imagery may be a combination of the values for x and y, for example. As an example the value of x for a first stream may be 75 kbps when the value of y for the second stream may be 150 kbps. When the mobile device 104 is able to only render imagery using the first stream, the data may be of a lower quality that has a total of 75 kbps. However, when the mobile device 104 is able to combine (add) the second stream of data with the first stream of data, the resulting imagery may have a higher quality having a total of 225 kbps (e.g., 75 kbps+150 kbps). The additive data in the second stream may be added to data in the first stream to provide a higher quality output.

In some embodiments, the streams may include data having different frames of data. For example, during a second of imagery, 24 total frames of images may be rendered by the mobile device 104 (or another number), assuming the mobile device 104 has received this many frames. In an example, the first stream may include every other frame. Thus, when the mobile device 104 only renders the first stream, the output will include 12 frames per second. The second stream may include the other 12 frames that were not transmitted during that second of time. Thus, when the first stream is added to the second stream, then the mobile device 104 may be able to provide the imagery at 24 frames per second, albeit with a slight delay. To remove the delay, the streams may alternate frames during a shorter period of time. Additional streams may also be used, such as each stream having a third, fourth, etc. amount o the frames.

In various embodiments, the additive streams may improve resolution with each additional stream that is able to be received by the mobile device 104. For example, the first stream may include the data shown in the block of pixels 708 in FIG. 7. The second stream of data may include the pixels 1012, which may be added to the block of pixels 708 to improve the resolution of the image. In another example, the first stream may include the block of pixels 802 while the second (or additional streams) may include higher details of the one or more portions 810 (e.g., face portion, etc.). Other additive configurations using multiple streams to improve the resolution are also contemplated. The mobile device 104 may then render the imagery in the streams that the mobile device 104 receives such that the mobile device renders a highest resolution available.

Any of the embodiments presented in FIGS. 7-13 (or any other embodiments or embodiments associated with other figures) may be used in combination with one or more of the other techniques described in the FIGS. 7-13 (or other embodiments). For example, the techniques shown in FIG. 8 may be combined with the techniques shown in FIG. 9 to provide borderless imagery having a high resolution in a face portion of the imagery, the techniques shown in FIG. 11 could be combined with any of the reductions in resolution, and so forth.

The amount of the reduction of resolution, frame rates, etc., may be determined dynamically based on information from the modem (e.g., via the process 400), and/or by other information available to the application 206 or the mobile device 102. Ultimately, the modem 230 may receive the modified data for transmission to anther device via the network 106.

### Illustrative Intermediary Processing

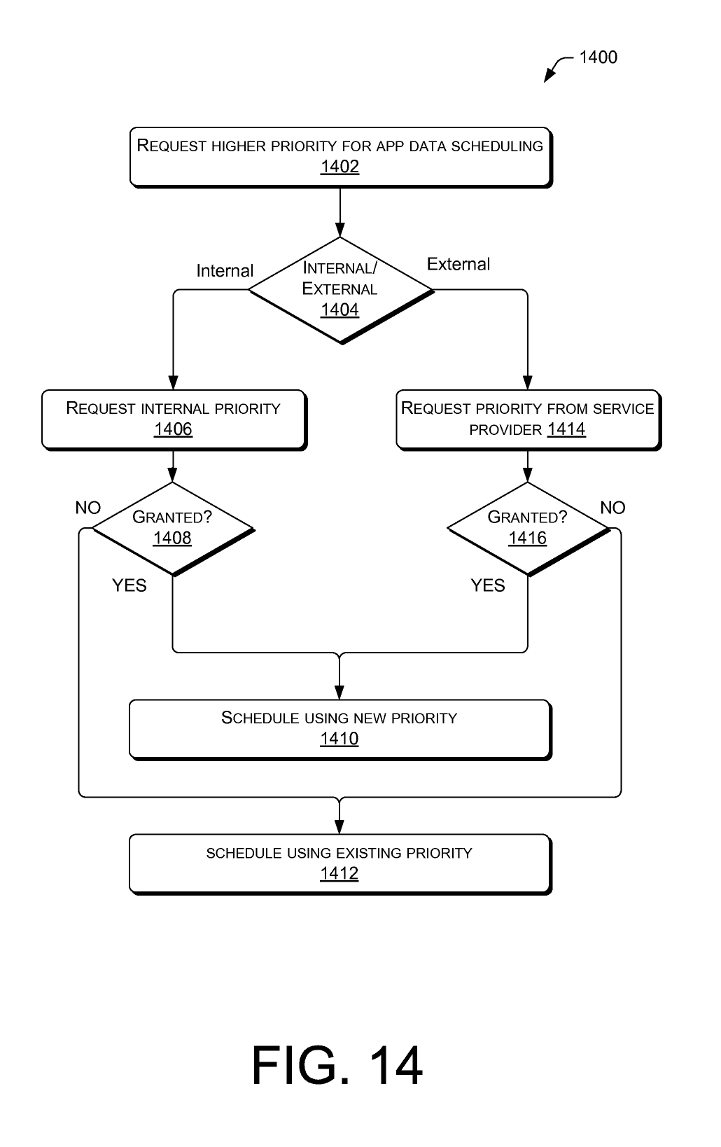

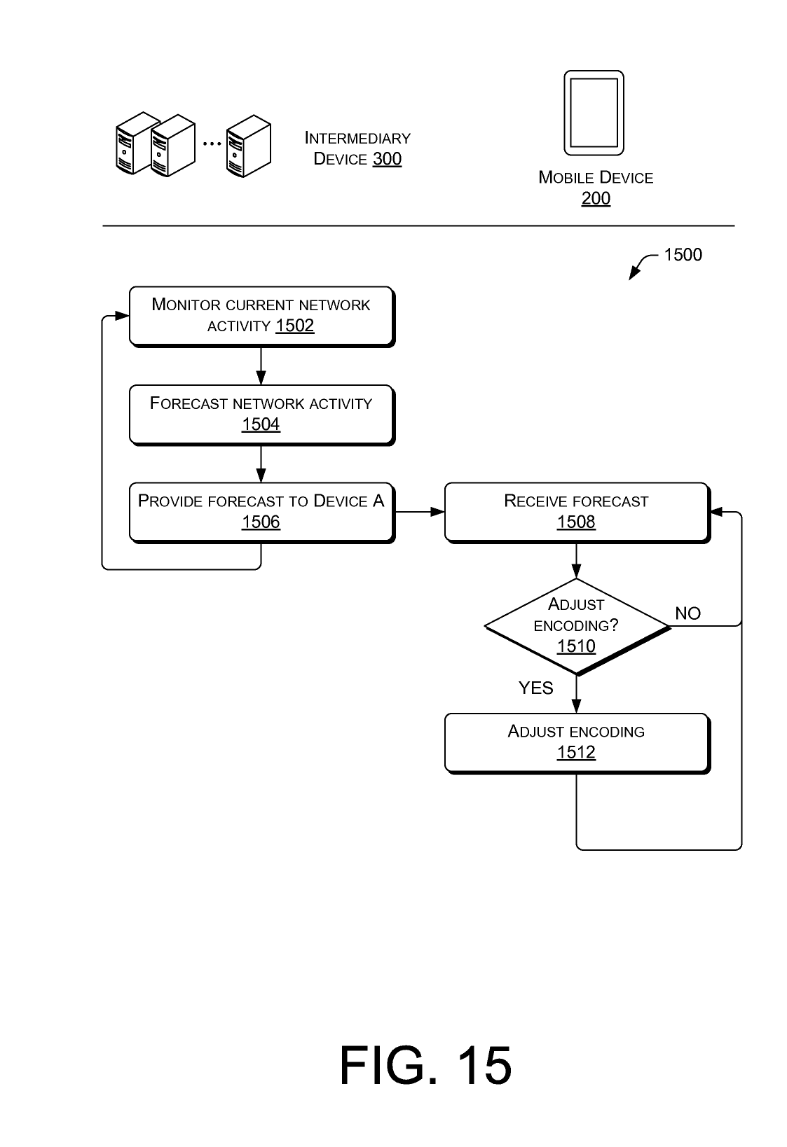

FIGS. 14 and 15 show illustrative processes of intermediary processing. The processes are illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 14 is a flow diagram of an illustrative process 1400 to implement greedy scheduling of data to be transmitted from a mobile device to another mobile device. The process 1400 may be performed by the mobile device 200 and/or by the intermediary device 300.

At 1402 the mobile device 200 may request a higher priority for application data scheduling. For example, the mobile device 200 may determine that the modem 230 is experiencing difficulties in transmitting the data across the network 106 in a timely manner.

At 1404, the mobile device 200 may determine whether to request a change in a priority of scheduling a transmission of data internally or externally from the mobile device. When the determination to request a change in the priority of scheduling a transmission of data internally, then the process 1400 may advance to the operation 1406.

At 1406, the mobile device 200 may request an internal priority of scheduling data from the application 206. For example, the mobile device 200 made prioritize transmission of data from the application 206 (e.g., a real-time video broadcast application, etc.) over transmission of data for other applications that are not prioritized (e.g., a web browser, a background app, etc.).

At 1408, the mobile device 200 may determine whether the request is granted. When the request is granted, and the operation 1410 may be performed to schedule data transmission using the new priority. However when the request is not granted, the operation 1412 may be performed to schedule the data transmission using the existing priority.

When the determination to request a change in the priority of scheduling a transmission of data externally, then the process 1400 may advance to an operation 1414. At 1414, the mobile device 200 may request an external priority of scheduling data generated by the application 206 from a service provider, such as the intermediary device 300 and/or another device in the network 106. For example, the intermediary device 300 may allow greedy scheduling by the mobile device 200 for transmission of data by the application 206. In another example, the mobile device 200 may request the RAN 108 to provide unfair scheduling. The unfair scheduling may be limited to use by the requesting application, such as the real-time video broadcasting application.

At 1416, the mobile device 200 may determine whether the request was granted. When the request was granted, then the process may advance to the operation 1410. When the period request was not granted, then the process may advance to the operation 1412.

FIG. 15 is a flow diagram of an illustrative process 1500 to forecast network activity and then adjust encoding of data based in part on the forecasted network activity. The process 1500 has operations organized under devices that may perform those operations. However, the operations may be performed by other devices.

At 1502, the intermediary device 300 may monitor current network activity. At 1504, the intermediary device 300 may forecast network activity. At 1506, the intermediary device 300 may provide the forecast to the mobile device 200. The operations 1502-1506 may repeat in a loop process.

At 1508, the mobile device 200 may receive the forecast from the intermediary device 300. At 1510, the mobile device 200 may determine whether to adjust encoding. For example, the mobile device 200 may determine that network bandwidth is going to reduce in the near future based on the received forecast at the operation 1508. When the mobile device 200 determines to adjust encoding, then the process may continue at an operation 1512.

At 1512, the mobile device 200 may just the encoding based at least in part on the received forecast at the operation 1508. Following the operation 1512, the process performed by the mobile device 200 may return to the operation 1508.

In some embodiments, the forecasting performed by the operations 1502-1506 may be performed by the mobile device by observing network activity of the network 106 during interaction with the network 106.

Although structural features and/or methodological acts are described above, it is to be understood that the appended claims are not necessarily limited to those features or acts. Rather, the features and acts described above are disclosed as example forms of implementing the claims.

What is claimed is:

1. A method comprising:
monitoring a quality of a network communication between a transmitting device and a receiving device;
recording a video using a camera of the transmitting device;
increasing a block size of a first portion of a frame in the video based at least in part on the monitoring of the quality of the network communication to create a modified video where the first portion includes a larger block size than a second portion of the frame of the modified video, the increasing the block size to reduce an amount of data used to transmit the modified video to the receiving device using the network communication; and
transmitting the modified video from the transmitting device to the receiving device via the network communication.

2. The method as recited in claim 1, wherein the increasing a block size of the first portion of the frame includes:
performing facial recognition on the frame to identify an area of the frame that includes a face;
designating the area of the frame that includes the face as the second portion of the frame; and
designating a remaining area of the frame, other than the area of the frame that includes the face, as the first portion of the frame.

3. The method as recited in claim 1, wherein the increasing a block size of the first portion of the frame includes:
determining a width of a border to apply to the frame;
designating the area of the border as the first portion of the frame; and
designating a remaining area of the frame, other than the area of the border, as the second portion of the frame.

4. The method as recited in claim 3, wherein the determining the width of the border to apply to the frame includes determining a dynamic width that is inversely proportional to the amount of data used to transmit the modified video to the receiving device.

5. The method as recited in claim 3, wherein the determining the width of the border to apply to the frame includes:
identifying a face in the frame using facial recognition; and
selecting the width to prevent overlap of the border and the face identified in the frame.

6. The method as recited in claim 1, wherein the quality of the network communication includes at least one of delay, throughput, signal strength, packet loss, capacity, or interference.

7. The method as recited in claim 1, wherein the monitoring the quality of the network communication is performed by receiving a buffer fill level from a modem of the transmitting device that indicates the quality of the network communication.

8. The method as recited in claim 1, wherein the monitoring the quality of the network communication is performed by receiving a downlink indicator from the receiving device that indicates the quality of the network communication experienced by the receiving device.

9. The method as recited in claim 1, further comprising, after a predetermined event, decreasing the block size of the first portion to a block size of the second portion.

10. A device comprising:
a camera;
a transceiver to provide communications to a destination device over a network;
a processor; and
memory to store instructions that, when executed by the processor, cause the processor to perform acts including:
monitoring a quality of a network communication with the destination device;
recording a video using the camera;
increasing a block size of a first portion of a frame in the video based at least in part on the monitoring of the quality of the network communication to create a modified video where the first portion includes a larger block size than a second portion of the frame of the modified video; and
transmitting the modified video to the destination device using the transceiver.

11. The device as recited in claim 10, wherein the acts further comprise performing facial recognition of the frame to detect an area of the frame that includes a face, and assigning the area that includes the face as the second portion of the frame.

12. The device as recited in claim 11, wherein the acts further comprise replacing at least part of the first portion of the frame with a border.

13. The device as recited in claim 10, wherein the acts further comprise determining a size of a border to apply to the frame, wherein the first portion of the frame is based at least in part on the size of the border.

14. The device as recited in claim 13, wherein the first portion of the frame is the border, and wherein the border includes imagery that is different than imagery of the frame that is recorded by the camera.

15. The device as recited in claim 10, further comprising a modem, and wherein the monitoring the quality is performed by receiving a buffer fill level from the modem that indicates the quality of the network communication.

16. A method comprising:
recording a video using a camera;
performing facial recognition on a frame of the video to identify an area of the frame that includes a face;
increasing a block size of another area of the frame, other than the area of the frame that includes the face, to create a modified video; and
transmitting the modified video to a destination device via a network communication.

17. The method as recited in claim 16, further comprising monitoring a quality of a network communication between a transmitting device and the destination device, and wherein the increasing the block size is based at least in part on the quality of the network communication.

18. The method as recited in claim 17, wherein the monitoring the quality is performed by receiving a buffer fill level from a modem that indicates the quality of the network communication.

19. The method as recited in claim 17, wherein the monitoring the quality of the network communication is performed by receiving a downlink indicator from the destination device that indicates the quality of the network communication experienced by the destination device.

20. The method as recited in claim 16, wherein the increasing the block size of another area of the frame includes converting at least a portion of the another area into a border depicted within the frame.
